(19) United States
(12) Patent Application Publication
(10) Pub. No.: US 2024/0195253 A1
(43) Pub. Date: Jun. 13, 2024

(54) STATOR OF AN ELECTRIC AXIAL FLUX MACHINE, AND AXIAL FLUX MACHINE

(71) Applicant: Schaeffler Technologies AG & Co. KG, Herzogenaurach (DE)

(72) Inventors: Michael MENHART, Igling (DE); Stefan RIESS, Kaufering (DE); Johann OSWALD, Eschenlohe (DE); Carsten SONNTAG, Gauting-Königswiesen (DE); Andrä CAROTTA, München-Hadern (DE)

(73) Assignee: Schaeffler Technologies AG & Co. KG, Herzogenaurach (DE)

(21) Appl. No.: 18/554,512

(22) PCT Filed: Apr. 8, 2022
(86) PCT No.: PCT/DE2022/100267

§ 371 Date: Oct. 9, 2023

(30) Foreign Application Priority Data
Apr. 10, 2021 (DE) 102021108953.0

(51) Int. Cl. H02K 3/28; H02K 1/16; H02K 1/18

(52) U.S. Cl. CPC H02K 3/28; H02K 1/16; H02K 1/182

(57) ABSTRACT

stator of an electric axial flux machine as well as to an electric axial flux machine. The stator of the axial flux machine includes a plurality of axially protruding stator teeth, a first winding being wound about at least one stator tooth, the first winding being surrounded on at least part of its radially outer face by at least one additional winding. The stator of an axial flux machine and the axial flux machine equipped with this stator afford durable units which combine an axially compact size with high performance.

### CROSS-REFERENCE TO RELATED APPLICATIONS

This application is the U.S. National Phase of PCT Appln. No. PCT/DE2022/100267, filed Apr. 8, 2022, which claims priority from German Patent Application No. 10 2021 108 953.0, filed Apr. 10, 2021, the entire disclosures of which are incorporated by reference herein.

### TECHNICAL FIELD

The disclosure relates to a stator of an electric axial flux machine as well as to an electric axial flux machine.

### BACKGROUND

The electric drive train is known from the prior art. This consists of components for energy storage, energy conversion and energy transmission. The energy conversion components include electric machines, for example axial flux machines. Axial flux machines are known from the prior art in various designs with one or more stators and one or more rotors.

An electrical axial flux machine, also referred to as a transverse flux machine, is a motor or generator in which the magnetic flux between a rotor and a stator is realized parallel to the axis of rotation of the rotor. Other names for electric axial flux machines are also brushless DC motors, permanently excited synchronous motors or disc motors.

Depending on the power range or application, it is often necessary to dissipate heat generated by various losses in electric machines through effective cooling. The cooling ensures that critical temperatures, which could lead to damage to materials and components, are avoided. In addition, the cooling contributes to improving the efficiency of the electric machine, since the ohmic resistance in electrical conductors in particular is highly temperature-dependent, which means that the power losses increase at higher temperatures.

The cooling of an electric rotary machine usually takes place largely in the stator. In the process, heat is dissipated from the wire coil to the surrounding housing or to the stator body itself and/or the surrounding air.

In particular in the case of electric machines which have a high torque or power density, surface cooling with heat dissipation to the surrounding air is often not sufficient, so that cooling with a cooling fluid is necessary. In principle, oils, water or water mixtures such as e.g. water-glycol, but also dielectric liquids, can be used.

However, the use of gaseous media, such as air, as a coolant is also not excluded.

There is usually also the requirement that the cooling system requires as little installation space as possible with little financial and technological effort and ensures optimum heat transfer.

A low axial installation space requirement is also often a central requirement criterion, regardless of the cooling implemented.

For high power densities, the winding of an electric machine must have a high copper fill factor. This is usually realized by using solid winding wire conductors. This type of winding is also referred to as rod winding. The conductors are referred to as rods. Rods of mostly rectangular cross section are often chosen.

A coil of a winding of an axial flux machine has a positive coil side and a negative coil side arranged circumferentially on the geometrically opposite side of a stator tooth, wherein both coil sides are positioned in grooves provided for this purpose, which form gaps between the stator teeth. The combination of several coils with a defined number of turns is referred to as the winding of an electric machine. A defined voltage is induced on each coil side of a winding in the magnetic field. Concentrated rod windings are known according to the prior art. In this form of winding, one or more rods are guided around the stator tooth at least once without interruption, such that there is a voltage induction of the same sign in each coil side.

The electromagnetic coupling between the winding and iron of other components of the electric machine results in changing forces on the winding during operation of the electric machine, which increase the risk of wear or fatigue.

If necessary, the windings are glued or clamped to the stator teeth and/or completely encapsulated with an epoxy resin.

In some known axial flux machines, the windings are implemented using a very large number of electrical conductors in the form of thin wires that wrap around a number of stator teeth.

An electric axial flux machine is known from WO 01/11755 A1, which has a stator on each side of a rotor. The stators, in turn, each have an annular yoke with grooves that extend radially from the inside to the outside, in which grooves multi-phase windings are guided.

In order to implement axially compact machines in particular, it is necessary to optimize or minimize the dimensions of the entire machine and the dimensions of the individual components. At the same time, however, the entire voltage induction of each phase must be guaranteed for the required no-load voltage by means of a suitable number of windings or coil sides in a suitable electrical circuit.

### SUMMARY

Proceeding from this, the object of the present disclosure is to provide a stator of an axial flux machine and a durable axial flux machine equipped with the stator, which combine an axially compact size with high performance.

This object is achieved by a stator of an axial flux machine and by an axial flux machine having one or more of the features disclosed herein. Advantageous embodiments of the stator of the axial flux machine are described below and in the claims.

The features of the claims can be combined in any technically useful manner, wherein the explanations from the following description as well as features from the figures can also be consulted for this purpose, which comprise supplementary embodiments of the disclosure.

The disclosure relates to a stator of an axial flux machine having a plurality of axially protruding stator teeth, wherein a first winding is wound about at least one stator tooth, said first winding being surrounded on at least part of its radially outer face by at least one additional winding.

In the context of the disclosure, a stator tooth is a projection that protrudes axially from a stator yoke, which has an essentially two-dimensional configuration, and around which an electrical conductor is wound, so that the electrical conductor forms a coil whose longitudinal axis is essentially parallel to an axis of rotation of an axial flux machine equipped with a rotor.

In the context of the present description and the claims, the terms “radial”, “axial” and “in the circumferential direction” relate to the winding around a stator tooth, unless explicitly stated otherwise.

The respective winding comprises a plurality of turns, which are guided around the stator tooth with a substantially uniform pitch, and thus form a coil for each stator tooth.

The first winding is executed directly adjacent to the stator tooth, although according to the disclosure it should not be ruled out that another layer or another element is arranged between the first winding and the stator tooth, such as a lacquer or insulating material.

On its radially outer side, the circumference of the first winding is surrounded by the further winding. There can be differences between the two windings with regard to the axial extents of the two windings.

The unit realized from the first winding and a respective further winding is also referred to as a winding pack.

In an advantageous embodiment of the stator, all of the stator teeth are provided with a first winding and with a further winding that wraps around the respective first winding.

Furthermore, the disclosure does not rule out the possibility that several further windings are arranged in relation to a respective stator tooth, wherein all windings are arranged radially nested within one another.

The radially nested arrangement of several windings or coils opens up the possibility of a significantly increased voltage induction or application of a voltage and thus a higher degree of efficiency. This means that the axial flux machine equipped with the rotor according to the disclosure can be built relatively short axially, or can be operated with a higher voltage while the axial length remains the same.

In an advantageous embodiment it is provided that the windings arranged on a respective stator tooth are electrically connected to one another in series.

In this case, windings arranged radially immediately adjacent to one another on a respective stator tooth can be electrically connected to one another by means of a respective connecting section.

For example, the windings arranged on a respective stator tooth can have the same pitch and/or the same winding direction.

In order to achieve a high current density, it can also be provided that the windings arranged on a respective stator tooth have rod-shaped longitudinal elements which run essentially radially in relation to the axis of rotation of an axial flux machine equipped with the rotor. Such rod-shaped longitudinal elements can also be referred to as rods.

In the usual configuration of the rotor, the axis of rotation of an axial-closure machine equipped with the rotor runs in the geometric center area or midpoint of the rotor.

A respective stator tooth comprises side surfaces aligned essentially perpendicular to the circumferential direction. In the case of the first winding, the rod-shaped longitudinal elements rest essentially on these side surfaces. Rod-shaped longitudinal elements of further windings are aligned essentially parallel to these side faces. For example, such a side surface can be designed to be essentially flat, such that rod-shaped longitudinal elements running parallel thereto are designed to be essentially linear.

The cross section of a rod-shaped longitudinal element can have a width B and a thickness D, wherein the following applies: B/D>1.5.

For arranging a large number of turns in a winding, the ratio can also be: B/D>2. In an electrically advantageous embodiment, it is provided that the geometric dimension with the greater length, i.e., the width here, extends radially to the axially running longitudinal axis of the stator tooth.

In an alternative embodiment, however, a round cross section of the rod-shaped longitudinal element is also possible.

Either the entirety of several windings arranged on a stator tooth, i.e., the winding pack, is made from a continuous wire or rod material, or at least one winding on the relevant stator tooth is made from a continuous wire or rod material.

In order to ensure the necessary positions of the turns of the windings, it can be provided that at least two of the rod-shaped longitudinal elements of at least one winding are fixed to one another.

Alternatively or additionally, it can be provided that at least two of the rod-shaped longitudinal elements of windings arranged directly adjacent to one another are fixed to one another.

As a result, the winding or its turns can be fixed and stiffened. In this way, alternating forces and thermo-mechanical stresses generated from the electromagnetic coupling between the winding and iron of other components of the electric machine in the alternating field of the electric machine can be distributed and thus more easily tolerated by the windings or turns.

For fixation, it is possible to connect the rods of the winding or several windings by sticking them together so that a coherent segment is created.

The rod-shaped longitudinal elements can also be fixed by gluing, encapsulating and/or a baked lacquer that adheres under heat, essentially at points or over an area.

A further advantageous embodiment provides that the first winding is spaced from the stator tooth by means of at least one radial spacer element, so that a free space is realized between a radial inside of the first winding and the stator tooth for the purpose of a cooling fluid flowing between them.

The size of a contact surface realized by the radial spacer element on the first winding can be, for example, at most 1/20 of the inner surface formed by the first winding opposite the stator tooth.

The radial distance between the first winding and the stator tooth realized by the radial spacer element is between 0.3 mm and 0.7 mm, for example. In particular, the radial distance can be 0.5 mm to 0.6 mm.

This radial distance ensures that the components can be directly cooled or flushed with a coolant while at the same time having a small installation space.

This results in significantly shorter thermal paths with a comparatively low thermal resistance, as a result of which a high current density in the winding wire and thus a high power density, i.e., a high current-carrying capacity of the winding, can be achieved.

At least one axial spacer element can be arranged between at least two rod-shaped longitudinal elements, such that a free space is realized between the rod-shaped longitudinal elements for the purpose of a cooling fluid flowing through them.

Here, too, an axial distance, realized here between rod-shaped longitudinal elements of the same winding, can be between 0.3 mm and 0.7 mm and in particular between 0.5 mm and 0.6 mm.

Furthermore, at least one spacing element can be arranged radially between windings arranged directly adjacent to one another, so that a free space is realized between these windings for the purpose of a cooling fluid flowing through them.

Here too, the distance, this time realized between rod-shaped longitudinal elements of a plurality of windings, can be between 0.3 mm and 0.7 mm and in particular between 0.5 mm and 0.6 mm.

At least one of the axial spacer elements, radial spacer elements and/or spacing elements can also be used to fix the rod-shaped longitudinal elements to one another, in which case the axial spacer elements, radial spacer elements and/or spacer elements can be used to completely or supportively fix the windings.

The stator according to the disclosure thus ensures direct cooling of the winding or windings via spacer elements or spacing elements to create gaps and spaces in a winding or between a winding and adjacent components. A coolant can flow through these gaps or spaces, wherein the distance between at least one element to be cooled and an opposite boundary of a respective flow channel is sufficiently large so that sufficient coolant can be conducted through the flow channel per unit of time and heat from power-carrying components can be transferred directly to the coolant and removed from it by means of convection.

Overall, the spacer elements or spacing elements ensure that the number and/or size of the surfaces of power-carrying components that can be contacted by the coolant is greatly increased compared to conventional axial flux machines, such that the cooling can take place very effectively.

In the case of several windings arranged radially nested in one another on a stator tooth, several or all of the windings arranged on this stator tooth can be designed according to the disclosure and/or connected to one another.

Due to the radially nested windings or coils, a very concentrated coil arrangement can be implemented overall in an axial flux machine, with a number of coil sides that is necessary in particular for the no-load voltage in the so-called corner point.

In an advantageous embodiment, each winding or coil has a defined number of turns, realized by individual rods or rod-shaped longitudinal elements electrically connected in series, which are stacked axially and thus form a respective layer of line elements on each side of the stator tooth.

The coil or winding arranged radially further out in this respect envelops the radially inner coil and comprises further series-connected rods or rod-shaped longitudinal elements in a further, enveloping layer. Each enveloping coil can have a different number of coil sides or rod-shaped longitudinal elements on one coil side.

A further aspect of the present disclosure is an axial flux machine which has at least one stator according to the disclosure. The axial flux machine according to the disclosure can have a stator, which is designed according to the present invention, on both axial sides of a rotor.

### BRIEF DESCRIPTION OF THE DRAWINGS

The disclosure above is explained in detail below against the pertinent technical background with reference to the accompanying drawings, which show preferred embodiments. The disclosure is not limited in any way by the purely schematic drawings, wherein it should be noted that the embodiments shown in the drawings are not limited to the dimensions shown. In the drawings:

FIG. 1: shows an axial flux machine in a perspective view,

FIG. 2: shows an axial flux machine in an exploded view,

FIG. 3: shows a stator of the axial flux machine in a perspective view,

FIG. 4: shows a winding pack in plan view,

FIG. 5: shows the winding pack in a perspective view,

FIG. 6: shows the winding pack in a sectional view along the section line C-C shown in FIG. 4,

FIG. 7: shows an enlarged section from FIG. 6,

FIG. 8: shows a sectional view of a stator tooth with a winding pack arranged thereon, and

FIG. 9: shows an enlarged section from FIG. 8.

### DETAILED DESCRIPTION

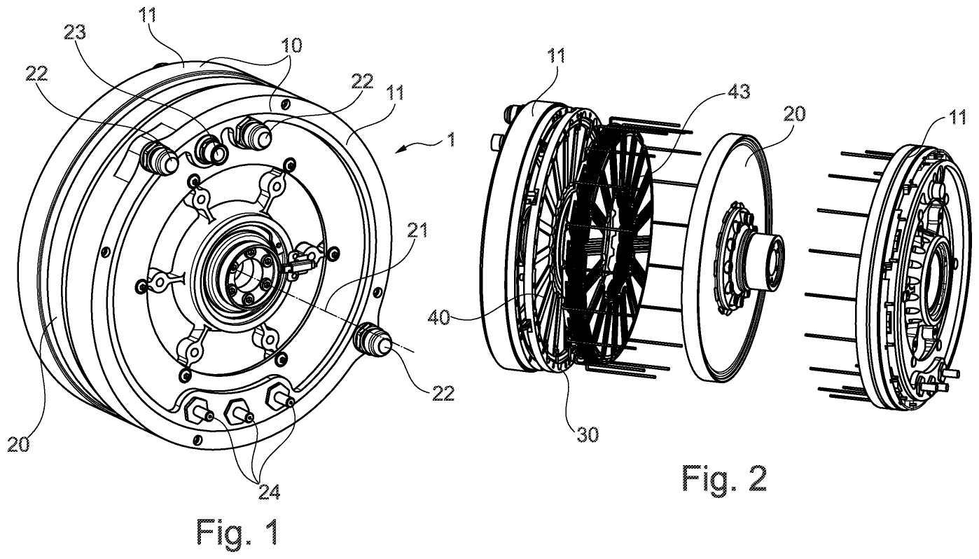

First, the general structure of an axial flux machine 1 is explained with reference to FIGS. 1 and 2.

The axial flux machine 1 shown in FIGS. 1 and 2 comprises, in the embodiment shown here, two stator halves 11 as the stator 10, between which the rotor 20, which is rotatable about an axis of rotation 21 with respect to the stator halves 11, is arranged axially.

In the embodiment shown here, a plurality of coolant connections 22 and a plug-in connection 23 for a control-related connection and a plurality of phase connections 24 are arranged on at least one stator half 11.

As can be seen from the exploded view in FIG. 2, each stator half 11 comprises a stator yoke 30, which can also be referred to as a stator core. Stator teeth 40 arranged essentially in a star shape extend in the axial direction from this stator yoke 30.

As can also be seen from the exploded view in FIG. 2, each stator half 11 also has a number of winding packs 43 corresponding to the number of stator teeth 40. A winding pack 43 is associated with each stator tooth 40. Only the first connections 56 of these winding packs 43 can be seen on the stator half 11 shown on the right in FIG. 2.

These first connections 56, which run essentially parallel to the axis of rotation of the axial flux machine, connect axially opposite winding packs 43 to one another.

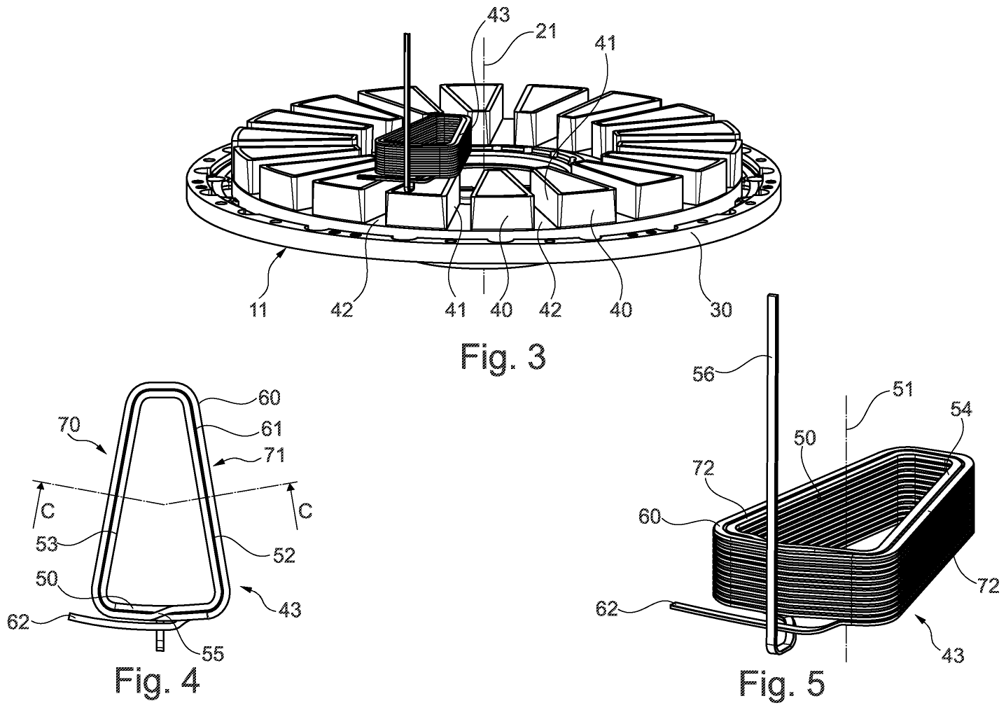

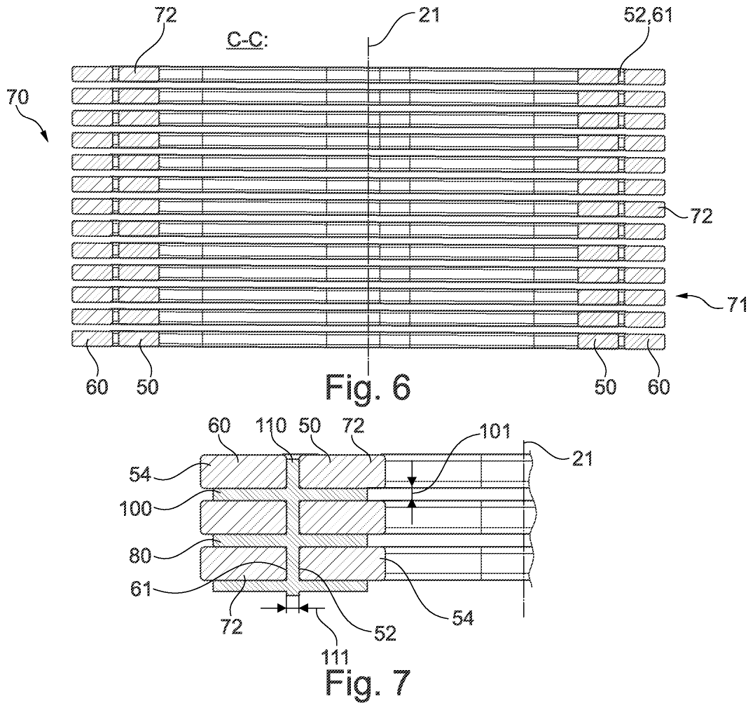

FIG. 3 shows the stator yoke 30 of a stator half 11 in a perspective view. The axially protruding stator teeth 40 are clearly visible here. Grooves 42 are formed between side surfaces 41 of a respective stator tooth 40. These grooves 42 serve to accommodate rod-shaped longitudinal elements 72, as indicated in FIG. 6, of a respective winding pack 43, as is also shown in FIG. 3 by way of example.

Such a winding pack 43 is shown in FIGS. 4 and 5 in different views. The winding pack 43 comprises a first winding, which can also be referred to as a first coil. The first winding 50 is radially surrounded by a further winding 60. Individual turns 54 of both windings 50,60 have the same pitch and/or the same winding direction.

The first winding 50 comprises a first connection 56 for making electrical contact, and the further winding 60 comprises a second connection 62 for making electrical contact with the winding pack 43. Between the two windings 50,60 there is a connecting section 55 for the electrical connection of the two windings 50,60 to one another.

Looking at FIGS. 3 and 5 together, it can be seen that the longitudinal axis 51 of the first winding 50 runs parallel to the axis of rotation 21 of the axial flux machine.

A respective winding 50, 60 comprises a plurality of turns 54, the components of which are the rod-shaped longitudinal elements 72, which are to be placed in the grooves 42.

FIG. 6 shows the winding pack 43 along the section line C-C indicated in FIG. 4. Here, the layered arrangement of the two windings 50,60 is clearly visible. It can be seen that the radially outer face 52 of the first winding 50 essentially corresponds to the radially inner face 61 of the further winding 60 or rests against it or is at a small distance from it. The winding pack 43 and also their individual windings 50, 60 form a first coil side 70 and a second coil side 71, wherein each coil side 70, 71 runs in its own groove 42.

It can be seen from FIG. 9 that the width B of a respective rod-shaped longitudinal element 72 is significantly greater than its thickness D.

This geometric design and the radial nesting of the two windings 50, 60 allow a large number of rod-shaped longitudinal elements 72 to be arranged for each stator tooth in a very short axial space, such that a comparatively high voltage is applied to the windings 50, 60 and thus to the stator, or can be induced here.

FIG. 7 shows that the individual turns 54 of the windings 50, 60 can be fixed to one another by means of one or more fixations 80. In this case, the windings 50, 60 arranged directly adjacent to one another or their turns 54 can be fixed to one another, for example by means of adhesive bonding. This fixation 80 in the radial direction also causes the formation of a spacing element 110 to form a radial distance 111 between the two windings 50, 60. The spacing element 110 can be formed partially between the two windings 50, 60, such that there is at least a gap between the two windings 50, 60 through which a coolant can flow for the purpose of cooling the windings 54.

In addition, the fixation 80 between individual windings 54 of the two windings 50, 60 also forms axial spacer elements 100, which each implement an axial distance 101 between the turns 54. A respective axial spacer element 100 can also be formed only partially between the turns 54 in order to leave gaps or cavities free here as well, through which a coolant can flow for the purpose of cooling the turns 54.

The fixation 80 ensures that the windings 50, 60 or their turns 54 withstand the acting electromagnetic forces in a sufficient manner.

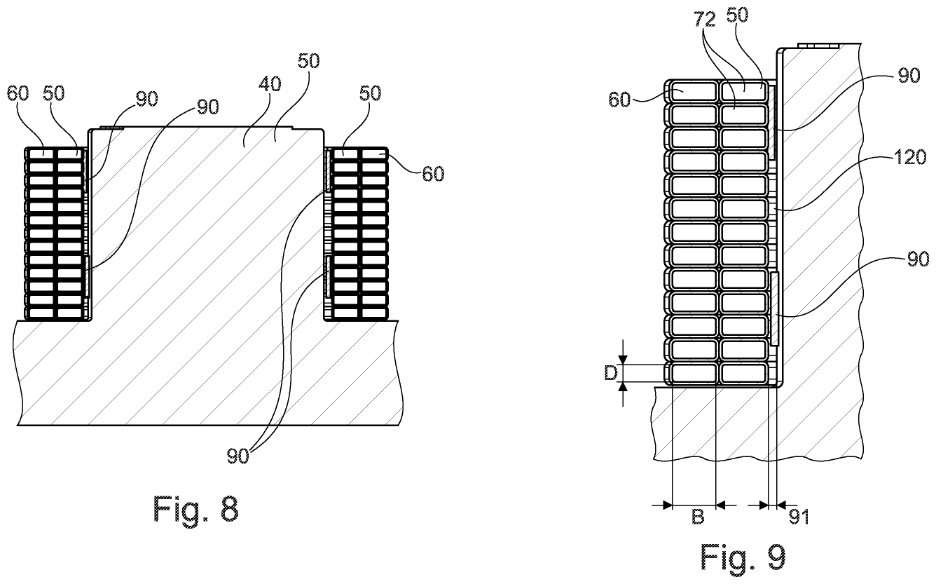

FIGS. 8 and 9 show the winding pack 43 on the stator tooth 40 in a sectional view. Here, it can be seen that between the radially inner face 53 or the inner surface 57 of the first winding 50 and the outer side of the stator tooth 40 a plurality of essentially punctiform radial spacer elements 90 are arranged. A radial distance 91 between the first winding 50 and the stator tooth 40 is realized by these radial spacer elements 90.

As a result, a clearance 120 is formed between the stator tooth 40 and the first winding 50, through which a coolant can flow, in order thus to dissipate heat from the first winding 50 via convection.

The proposed stator of an axial flux machine and the axial flux machine equipped with said stator afford durable units which combine an axially compact size with high performance.

### LIST OF REFERENCE SYMBOLS

1 Axial flux machine
10 Stator
11 Stator half
20 Rotor
21 Axis of rotation
22 Coolant connection
23 Plug-in connection
24 Phase connection
30 Stator yoke
40 Stator tooth
41 Side face
42 Groove
43 Winding pack
50 First winding
51 Longitudinal axis
52 Radially outer face of the first winding
53 Radially inner face of the first winding
54 Turn
55 Connecting section
56 First connection
57 Inner surface
60 Further winding
61 Radial inner face of the further winding
62 Second connection
70 First coil side
71 Second coil side
72 Rod-shaped longitudinal element
80 Fixation
90 Radial spacer element
91 Radial distance
100 Axial spacer element
101 Axial distance
110 Spacing element
111 Distance
120 Clearance
B Width
D Thickness

1. A stator of an axial flux machine, comprising:
a plurality of axially protruding stator teeth;
a first winding wound about at least one of the stator teeth; and
at least one additional winding that at least partially surrounds a radially outer face of said first winding.

2. The stator of an axial flux machine according to claim 1, wherein first winding and the at least one additional winding arranged on a respective one of the stator teeth are electrically connected in series with one another.

3. The stator of an axial flux machine according to claim 2, wherein the first winding and the at least one additional winding arranged radially directly adjacent to one another on the respective one of the stator teeth are electrically in each case connected to one another by a connecting section.

4. The stator of an axial flux machine according to claim 1, wherein the first winding and the at least one additional winding arranged on the respective one of the stator teeth have at least one of a same pitch or a same winding direction.

5. The stator of an axial flux machine according to claim 1, wherein the first winding and the at least one additional winding arranged on the respective one of the stator teeth have rod-shaped longitudinal elements which run essentially radially with respect to an axis of rotation of an axial flux machine equipped with a rotor.

6. The stator of an axial flux machine according to claim 5, wherein a cross section of one said rod-shaped longitudinal element has a width B and a thickness D, wherein B/D>1.5.

7. The stator of an axial flux machine according to claim 5, wherein at least two of the rod-shaped longitudinal elements of at least one of the first winding or the at least one additional winding are fixed to one another.

8. The stator of an axial flux machine according to claim 5, wherein at least two of the rod-shaped longitudinal elements are fixed to each other by the first winding and the at least one additional winding arranged directly adjacent to one another.

9. The stator of an axial flux machine according to claim 1, wherein the first winding is spaced apart from the stator tooth by means of at least one radial spacer element, such that a free space is located between a radial inner side of the first winding and the stator tooth that is adapted for a cooling fluid flow therebetween.

10. An axial flux machine, comprising at least one stator according to claim 1.

11. A stator of an axial flux machine, comprising:
a plurality of axially protruding stator teeth;
a first winding wound about at least one of the stator teeth;
an additional winding that at least partially surrounds a radially outer face of said first winding; and
a connecting section electrically connecting the first winding and the additional winding.

12. The stator of an axial flux machine according to claim 11, wherein the first winding and the additional winding arranged on a respective one of the stator teeth are electrically connected in series with one another by the connecting section.

13. The stator of an axial flux machine according to claim 12, wherein the first winding and the additional winding are arranged radially directly adjacent to one another on the respective one of the stator teeth.

14. The stator of an axial flux machine according to claim 11, wherein the first winding and the additional winding arranged on the respective one of the stator teeth have at least one of a same pitch or a same winding direction.

15. The stator of an axial flux machine according to claim 11, wherein the first winding and the additional winding arranged on the respective one of the stator teeth have rod-shaped longitudinal elements which run essentially radially with respect to an axis of rotation of a rotor that is adapted to be located within the stator.

16. The stator of an axial flux machine according to claim 15, wherein a cross section of one said rod-shaped longitudinal element has a width B and a thickness D, wherein B/D>1.5.

17. The stator of an axial flux machine according to claim 15, wherein at least two of the rod-shaped longitudinal elements of at least one of the first winding or the additional winding are fixed to one another.

18. The stator of an axial flux machine according to claim 15, wherein at least two of the rod-shaped longitudinal elements are fixed to each other by the first winding and the additional winding arranged directly adjacent to one another.

19. The stator of an axial flux machine according to claim 11, wherein the first winding is spaced apart from the stator tooth by at least one radial spacer element, such that a free space is located between a radial inner side of the first winding and the stator tooth that is adapted for a cooling fluid flow.
